(19) United States
(12) Patent Application Publication
(10) Pub. No.: US 2025/0168145 A1
(43) Pub. Date: May 22, 2025

(54) SSID ASSOCIATION WITH ADDRESS INFORMATION

(71) Applicant: Nokia Technologies Oy, Espoo (FI)

(72) Inventors: Jianguo LIU, Shanghai (CN); Zhijie YANG, Shanghai (CN); Yan MENG, Shanghai (CN); Tao TAO, Shanghai (CN); Wenjian WANG, Shanghai (CN)

(21) Appl. No.: 18/834,728

(22) PCT Filed: Feb. 14, 2022
(86) PCT No.: PCT/CN2022/076223

§ 371 Date: Jul. 31, 2024

(51) Int. Cl. H04L 61/5038; H04L 61/5092; H04L 101/622; H04W 8/26; H04W 84/12

(52) U.S. Cl. CPC H04L 61/5038; H04L 61/5092; H04W 8/26; H04L 2101/622; H04W 84/12

(57) ABSTRACT

Example embodiments of the present disclosure relate to SSID association with address information. A network device obtains an address generation mode indication from a terminal device. The address generation mode indication indicates that address information of the terminal device is generated in a static mode or a dynamic mode. The network device further receives a probe request message comprising the address information from the terminal device. The network device further determines an SSID for the terminal device based, at least in part, on the address information and associates the SSID with the address information. In this way, a unique SSID associated with address information of the terminal device can be assigned to the terminal device, which ensures the terminal device to fast associate the network.

### FIELD

Embodiments of the present disclosure generally relate to the field of wireless communication and in particular, to methods, devices, apparatus and computer readable storage medium for service set identifier (SSID) association with address information.

### BACKGROUND

Wireless communication networks such as wireless local area network (WLAN) and Wireless Fidelity (Wi-Fi) network are widely utilized to provide various communication services such as voice, video, packet data, messaging, broadcast, etc. Distributed wireless communication network with a controller and multiple access points (APs) has been proposed to enhance the network coverage and performance. For example, a controller of the network may create a private virtual basic service set (VBSS) network for an individual terminal device or station (STA). Each individual terminal device can access the private VBSS based on SSID and password (PWD) pair information allocated by the controller. Works are ongoing to introduce SSID associated with address information of the terminal device for VBSS, to improve the network coverage and performance.

### SUMMARY

In general, example embodiments of the present disclosure provide methods, devices, apparatus and computer readable storage medium for SSID association with address information.

In a first aspect, there is provided an apparatus. The apparatus comprises at least one processor; and at least one memory storing instructions that, when executed by the at least one processor, cause the apparatus at least to obtain, from a terminal device, an address generation mode indication. The address generation mode indication is indicative of address information of the terminal device being generated in a static mode or a dynamic mode. The apparatus is further caused to receive, from the terminal device, a probe request message comprising the address information of the terminal device. The apparatus is further caused to determine an SSID for the terminal device based, at least in part, on the address information. The apparatus is further caused to associate the SSID with the address information.

In a second aspect, there is provided an apparatus. The apparatus comprises at least one processor; and at least one memory storing instructions that, when executed by the at least one processor, cause the apparatus at least to determine an address generation mode indication to be transmitted to a network device in a network. The address generation mode indication is indicative of address information of the apparatus being generated in a static mode or a dynamic mode. The apparatus is further caused to transmit, to the network device, a probe request message comprising the address information of the apparatus. The apparatus is further caused to receive a probe response message comprising an SSID. The SSID is determined by the network device based, at least in part, on the address information.

In a third aspect, there is provided a method. In the method, a network device obtains, from a terminal device, an address generation mode indication. The address generation mode indication is indicative of address information of the terminal device being generated in a static mode or a dynamic mode. The network device further receives, from the terminal device, a probe request message comprising the address information of the terminal device. The network device further determines an SSID for the terminal device based, at least in part, on the address information; and associate the SSID with the address information.

In a fourth aspect, there is provided a method. In the method, a terminal device determines an address generation mode indication to be transmitted to a network device in a network. The address generation mode indication is indicative of address information of the terminal device being generated in a static mode or a dynamic mode. The terminal device further transmits, to the network device, a probe request message comprising the address information of the terminal device. The terminal device further receives a probe response message comprising an SSID. The SSID is determined by the network device based, at least in part, on the address information.

In a fifth aspect, there is provided an apparatus. The apparatus comprises means for performing the method according to the third aspect or the fourth aspect.

In a sixth aspect, there is provided a computer readable medium. The computer readable medium comprises program instructions for causing an apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates example architecture of terminal device roaming according to some example embodiments of the present disclosure;

FIG. 3 illustrates a signaling flow for communication according to some example embodiments of the present disclosure;

FIG. 4 illustrates a flowchart of a method implemented at a network device according to some example embodiments of the present disclosure;

FIG. 5 illustrates a flowchart of a method implemented at a terminal device according to some example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), wireless local area network (WLAN) and Wireless Fidelity (Wi-Fi) network and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an JAB node behaves like a base station toward the next-hop IAB node.

The term “terminal device” refers to any end device that may be capable of wireless communication. By way of example rather than limitation, a terminal device may also be referred to as a communication device, a station (STA), user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoTP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an JAB node (e.g., a relay node). In the following description, the terms “terminal device”, “communication device”, “terminal”, “STA”, “user equipment” and “UE” may be used interchangeably.

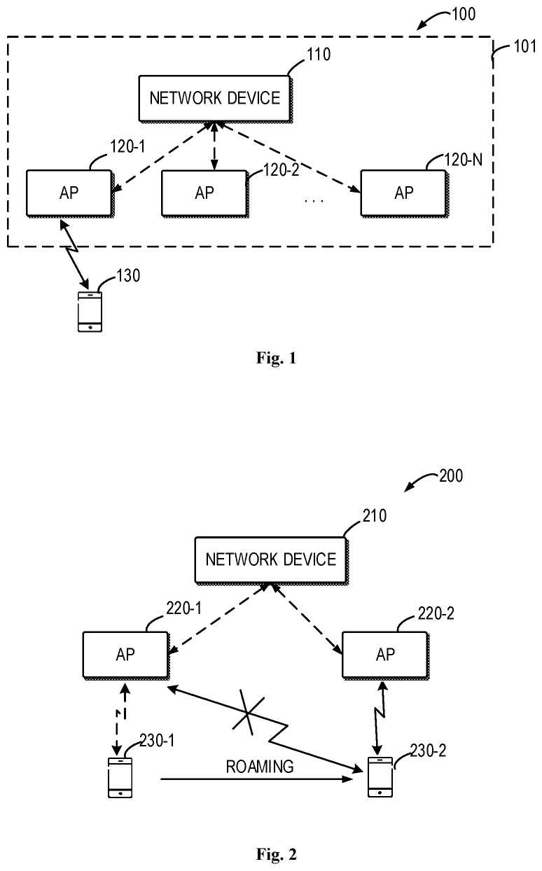

Principle and implementations of the present disclosure will be described in detail below with reference to FIGS. 1-7.

### Example Communication Environment

FIG. 1 shows an example communication environment 100 in which embodiments of the present disclosure can be implemented. In the communication environment 100, a distributed network 101 provides various communication services to a terminal device 130. The distributed network 101 comprises a network device 110 and a plurality of APs comprising AP 120-1, AP 120-2, . . . , and AP 120-N. As used herein, the term of “distributed network” may also be referred to as “distributed wireless network” or “multi-AP network”. Example of distributed network 101 may comprise but not limited to WLAN network, Wi-Fi Easy Mesh network, etc. Examples of the network device 110 may comprise but not limited to a controller, a multi-AP controller or any other suitable devices or apparatus. The network device 110 is configured to implement logic for controlling the operation of the distributed network 101. The network device 110 may be configured to access the Internet through wide area network (WAN) port.

As used herein, the term of “AP” may also be referred to as “AP agent” or “Multi-AP agent” or “AP node”. For ease of discussion, the APs 120-1, 120-2, . . . , and 120-N may be collectively referred to as “APs 120” or individually referred to as an “AP 120”. The AP 120 may be a compliant logical entity and configured to execute AP control functions and provide Multi-AP specific control information. One AP 120 of the plurality of APs 120 may be configured to provide communication services to the terminal device 130. The APs 120 may be configured to communicate with each other via backhaul.

In some example embodiments, the terminal device 130 may be always connected to a best AP 120 (for example, the AP 120-1 as shown in FIG. 1) of the plurality of APs 120. For example, the network device 110 may be configured to create a private VBSS network for the terminal device 130. The VBSS allows the Basic Service Set (BSS) context to be moved from one AP 120 to another AP 120, and from one band to another, by using for example make before break (MBB) technology to move the terminal device 130. In such cases, the terminal device 130 will not need to re-associate or re-negotiate security. By continuous passive monitoring of the terminal device 130 connection, the terminal device 130 can be moved to the best radio and band on the best AP 120 resulting in no reduction in throughput. The terminal device 130 in the VBSS network may be seamlessly connected to any AP node 120 and view all APs 120 in the distributed network 102 as one single AP 120.

It is to be understood that the number of network device(s), APs and terminal device(s) and their connections as shown in FIG. 1 is only for the purpose of illustration without suggesting any limitations. The communication environment 100 may include any suitable number of network device(s), APs and terminal device(s) adapted for implementing embodiments of the present disclosure. Although not shown, it would be appreciated that one or more additional network devices may be located in the distributed network 101, each additional network device may be associated with at least one AP, and one or more additional terminal devices may be located in the environment 100.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example Terminal Device Roaming

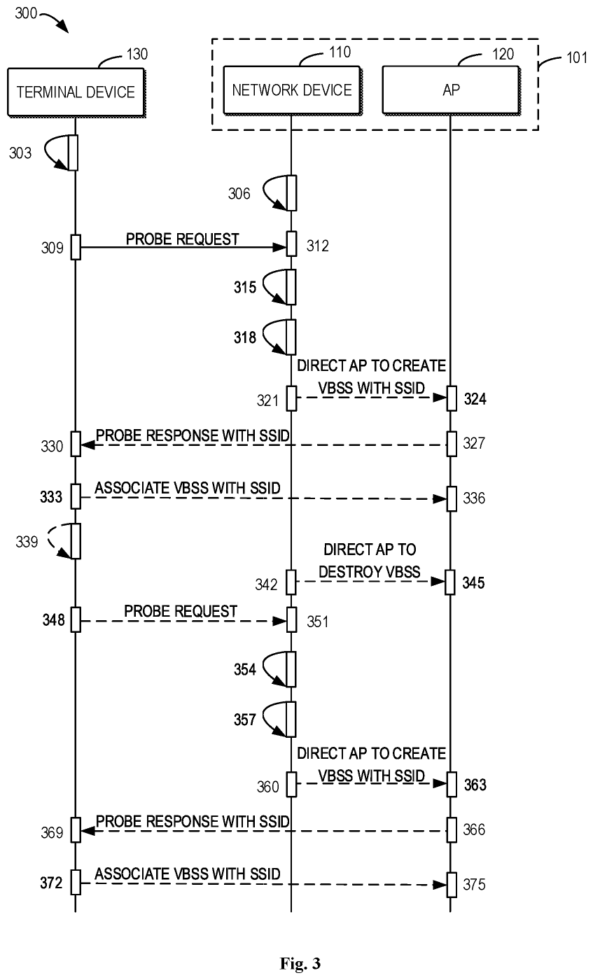

As briefly mentioned above, the terminal device can be always connected to a best AP of the plurality of APs in the distributed network. When the terminal device roams from one place to another, the AP to which the terminal device connected may change. FIG. 2 illustrates example architecture 200 of terminal device roaming according to some example embodiments of the present disclosure. In FIG. 2, a network device 210 is configured to control an AP 220-1 and an AP 220-2. The network device 210 and APs 220-1 and 220-2 may form a distributed network. A terminal device 230 may have access to the distributed network.

For example, when the terminal device 230 moves to a first place (as used herein, the terminal device 230-1 represents that the terminal device 230 is at the first place), the terminal device 230-1 may perform active scan on all channels. The AP 230-1 may detect a better received channel power indicator (RCPI) or received signal strength indication (RSSI). The network device 210 may direct the AP 220-1 to create a VBSS and provide communication services to the terminal device 230-1. When the terminal device 230 roams to a second place (as used herein, the terminal device 230-2 represents that the terminal device 230 is at the second place), the AP 220-2 may detect a better RCPI or RSSI over the AP 220-1, then the controller 210 may direct the AP 220-1 to destroy the VBSS and direct the AP 220-2 to create a VBSS for the terminal device 230-2.

After the AP creates a private VBSS network for the terminal device, the terminal device is configured to access the private VBSS based on SSID and PWD pair information allocated by the network device. According to one approach, each AP will set up a normal BSS with the same SSID (for example, SSID-Home). For example, a first AP may set up a normal BSS1 with “SSID-Home”, and a second AP may set up a normal BSS2 with “SSID-Home”. If the terminal device performs active scan on all channels, the terminal device may find the normal BSS with SSID of “SSID-Home” based on the probe response frame transmitted by the APs in the distributed network. The network device may determine that the first AP is a best AP and make decision to create a private VBSS network with SSID of “SSID-Private” on the first AP. The VBSS may be represented as “BSS3: SSID-Private”. Then, the first AP sends an unsolicited unique probe response to the terminal device so that the terminal device may find the private VBSS with SSID of “SSID-Private”. The terminal device may then set up a connection to the private network “SSID-Private” with some guidance information.

If the terminal device moves from one place to another place, where the second AP detects a better RCPI or RSSI then the first AP, the network device may make a transfer decision. The second AP may create a private VBSS (“BSS4: SSID-Private”) with the same BSSID and SSID as the BSS3 at the first AP. At the same time, the first AP may share all key information on the terminal device to the second AP via backhaul link and the network device. After that, the private VBSS (BSS3) at the first AP will be closed in silence, and the private VBSS network (BSS4) at the second AP will become the new serving AP automatically.

However, such approach has some drawbacks. In some cases, a plurality of terminal devices can be associated to the same BSS, as such approach will not allocate a unique SSID per terminal device. However, a private VBSS in the distributed network can only serve one terminal device, thus the SSID of the VBSS shall be unique for each terminal device. For example, if the plurality of terminal devices uses a same SSID to get access to the private VBSS, the network device may need to recognize or verify these terminal devices.

In some cases, the network device may create a private VBSS with the SSID which is managed on both the network side and the terminal device side after receiving the probe request from the terminal device. Therein, it is desirable to automatically associate the SSID of the private VBSS with the terminal device upon receiving the probe request message from the STA. However, if the terminal device uses a dynamic MAC address instead of a static MAC address, then using an existing SSID to get access to the private VBSS may be refused by the network. That is, in such cases, the terminal device cannot be automatically associated with the SSID of the private VBSS.

As discussed above, it is challenging to create VBSS for the terminal device based on the SSID. According to some example embodiments of the present disclosure, there is provided a scheme for SSID association with address information for VBSS. In this solution, a network device obtains an address generation mode indication from a terminal device. The address generation mode indication indicates that the address information of the terminal device is generated in a static mode or a dynamic mode. The network device receives a probe request message from the terminal device. The probe request message comprises the address information of the terminal device generated in a mode indicative by the address generation mode indication. The network device further determines an SSID for the terminal device based, at least in part on the address information and associates the SSID with the address information. The terminal device may receive a probe response message comprising the SSID determined by the network device and access the network using the SSID.

By associating the SSID with the address information of the terminal device, the network device may ensure the uniqueness the SSID used for each terminal device to associate with the distributed network. In addition, the terminal device may fast associate the existing network based on the association between the SSID and the address information.

Example SSID Association with Address Information

FIG. 3 illustrates a signaling flow 300 for communication according to some example embodiments of the present disclosure. As shown in FIG. 3, the signaling flow 300 involves a terminal device 130, a network device 110 and an AP 120 in a distributed network 101. It is to be understood that although only one AP is illustrated in FIG. 3, the signaling flow 300 will involve more than one AP under control of the network device 110 in the distributed network 101. For the purpose of discussion, there are three devices illustrated in FIG. 3.

In operation, the terminal device 130 determines (303) an address generation mode indication. The terminal device 130 may intend to access a private VBSS of the distributed network 101. The address generation mode indication indicates that address information of the terminal device 130 is generated in a static mode or a dynamic mode. The address generation mode indication is to be transmitted to the network device 110. For example, the terminal device 130 may determine the address generation mode indication by negotiating an address generation mode with the network device 110 and determining the address generation mode indication based on the negotiated address generation mode. In another example, the terminal device 130 may determine the address generation mode as default or based on other suitable rule, and determine the address generation mode indication based on the determined address generation mode. In some example embodiments, the address information of the terminal device 130 may comprise a MAC address of the terminal device 130. In such cases, the address generation mode may also be referred to as a MAC address generation mode or a MAC address generation rule.

The network device 110 obtains (306) the address generation mode indication from the terminal device 130. In some example embodiments, if capability is supported for the terminal device 130, the network device 110 may obtain (306) the address generation mode indication by negotiating the address generation mode with the terminal device 130 and determining the address generation mode indication based on the negotiated address generation mode. For example, the network device 110 may negotiate the MAC address generation mode with the terminal device 110 after the terminal device 130 associates or accesses the distributed network 101 (for example, a normal BSS or a private VBSS of the distributed network 101).

In some example embodiments, the network device 110 may receive capability information from the terminal device 130. The network device may further obtain (306) the address generation mode indication based on the capability information. For example, the network device 110 may collect the MAC address generation mode from the terminal device 130 for example through UE capability report. As an example, the terminal device 130 may report the capability information to the network device 110, for example when the terminal device 130 transmits (309) a probe request message to the network device 110, or when the terminal device 130 associates or accesses the distributed network 101.

Alternatively, or in addition, if the network device 110 can't obtain the address generation mode indication by negotiation or by the received capability information, the network device 110 may obtain (306) the address generation mode indication by default. For example, the network device 110 may determine the address generation mode indication to indicate a default static mode or as a default dynamic mode.

In this way, the present solution may support both the static MAC address generation mode and the dynamic MAC address generation mode, thus tracking the terminal device may be prevented.

In some example embodiments, the terminal device 130 may perform active scan on all channels, and attempt to sign onto the normal BSS network hosted by one of the plurality of APs 120 in the distributed network 101.

The terminal device 130 transmits (309) a probe request message to the network device 110. As used herein, the term of “probe request message” may also be referred to as “probe request frame” or “probe request”. The probe request message comprises address information of the terminal device 130. For example, the terminal device 130 may transmit (309) the probe request message to perform channel scan where a MAC address of the terminal device 130 is carried by or included in the probe request message.

In some example embodiments, the address information of the terminal device 130 may comprise a static MAC address. The static MAC address may be pre-configured for the terminal device 130. In such cases, the address generation mode indication obtained (306) by the network device 110 may indicate a static mode.

In some example embodiments, the address information of the terminal device 130 may comprise a dynamic MAC address. Such MAC address may be generated based on a certain rule. For example, the MAC address may be random rotating MAC addressed which is obtained based on a random seed and a base address. The random seed may be a configured parameter, for example, security key or timing information. The random seed may be known by both the terminal device 130 and the network device 110. In such cases, the address generation mode indication obtained (306) by the network device 110 may indicate the dynamic address generation mode or rule.

The network device 110 receives (312) the probe request message. Upon receiving (312) the probe request message from the terminal device 130, the network device 110 may decide to create a new unique VBSS for the terminal device 130. For example, the network device 110 may make the decision based on the number of BSSs available, historical knowledge of the terminal device 130, etc.

The network device 110 determines (315) an SSID for the terminal device 130 based, at least in part, on the address information comprised in the probe request message. For example, the network device 110 may generate the SSID based on the address information and the address generation mode indication. The network device 110 further associates (318) the SSID with the address information. For example, the network device 110 may generate a unique SSID and associate or bundle the unique SSID with the MAC address of the terminal device 130 based on a specific association or bundling rule obtained from the normal BSS of the distributed network 101. The specific association or bundling rule may be determined based on the MAC address generation mode or the MAC address generation mode indication of the terminal device 130.

In some example embodiments, a static MAC addressed is applied for the terminal device 130. That is, the MAC address of the terminal device 130 may be a static MAC address. In such cases, the address generation mode indication obtained (306) by the network device 110 may indicate a static MAC address generation mode. In such cases, the network device 110 may obtain the MAC address comprised in the address information. The network device 110 may further associate (318) the SSID with the MAC address. That is, the SSID determined or generated by the network device 110 may be directly associated or bundled with the MAC address of the terminal device 130 detected from the probe request message transmitted (309) by the terminal device 130.

Alternatively, in some example embodiments, the MAC address of the terminal device 130 is dynamically generated based on a specific rule. In such cases, the address generation mode indication obtained (306) by the network device 110 may indicate a dynamic address generation mode or rule. In such cases, the network device 110 may associate (318) the SSID with the MAC address of the terminal device 130 based on a corresponding rule.

For example, the network device 110 may obtain the MAC address comprised in the address information. The network device 110 may obtain a base address based on the MAC address and the dynamic address generation mode indication. The network device 110 may further associate (318) the SSID with the base address. As an example, the MAC address of the terminal device 130 is generated based on random MAC address rotation where the random seed is generated based on the security key of the terminal device 130 or other parameters. In such cases, the network device 110 may calculate the base address through the rotating MAC address and the security key information. Then, the calculated base address may be associated or bundled with the SSID.

In this way, both the station MAC address and the dynamic MAC address can be associated with the unique SSID determined by the network device. Particularly, for the dynamic MAC address cases, it may help to reduce the privacy risk. In this way, the present application may be applicable for dynamic or random MAC address allocation for the terminal device based on flexible association approach.

In some example embodiments, the network device 110 may store the association or the correlation between the SSID and the address information such as the MAC address. For example, the network device 110 may store the association at the distributed network 102, such as at the network device 110 or at a local database. For example, in the static MAC address cases, a table may be created to record the mapping relationship between the MAC address and the SSID. In another example, in the dynamic MAC address cases, a table may be created to record the mapping relationship between the base address and the SSID. By storing the association, the terminal device 130 may automatically associate with the VBSS by using the existing SSID. Such automatic association will be described in details below.

Alternatively, or in addition, in some example embodiments, the network device 110 may update or clean the stored associations periodically. In this way, the network device 110 may appropriately manage the terminal devices accessed to the distributed network 101 and also save the storage cost of the distributed network 101.

The network device 110 may direct (321) the AP 120 to create (324) a VBSS with the SSID for the terminal device 130. The network device 110 may also trigger the AP 120 to send (327) the probe response message to the terminal device 130. The probe response message comprises the SSID determined by the network device 110. The AP 120 may be selected from the plurality of APs 120 based on the RCPI or RSSI. For example, the network device 110 may transmit a VBSS request message to the AP 120. In response to the VBSS request message, the AP 120 may send a VBSS response message to the network device 110. The VBSS response messages comprise one or more VBSS Creation tag-length-values (TLVs). The VBSS response may inform the network device 110 when the VBSS has been instantiated and is ready to receive or transmit packets.

In response to receiving (330) the probe response message with the SSID from the AP 120, the terminal device 130 may associate (333) the VBSS with the SSID. That is, the VBSS created by the AP 120 may be associated (336) with the SSID. For example, the terminal device 130 may connect with the AP 120 (also referred to as the serving agent) of the private VBSS using the SSID via high layer application operation, for example, if the SSID and PWD pair information is verified by the network 101 (such as the network device 110). In addition, the terminal device 130 may set up wireless connection with the AP 120 automatically as the SSID provided by the private VBSS is mapped to the existing SSID information in the local database.

In this way, the network device 110 may detect the MAC address of the terminal device 130 from the probe request message, and generate a unique SSID for the terminal device 130. The unique SSID is bundled or associated with the MAC address of the terminal device 130 based on a specific association or bundling rule. The network device 110 may further use the unique SSID to create a private VBSS network for the terminal device 130. The terminal device 130 may access the private VBSS network based on the unique SSID. Thus, the uniqueness of the SSID used for a respective terminal device to be associated with the distributed network may be ensured.

The terminal device 130 may move (339) to a location out of the coverage of the VBSS network. In response to detecting that the terminal device 130 is out of the coverage of the VBSS, the network device 110 may cause (342) the AP 120 (or the serving agent) to destroy or remove (345) the VBSS. For example, if triggered to destroy or remove the VBSS, the network device 110 may send a VBSS request message to the AP 120 where the SSID may be indicated through the VBSS request message. In response to the request, the AP 120 may send a VBSS response message, containing one or more VBSS Destruction TLVs. The VBSS Response message may inform the network device 110 when the VBSS has been removed or destroyed.

In some example embodiments, the terminal device 130 may need to access the distributed network 101 again. According to some example embodiments, the terminal device 130 may automatically connect the private VBSS network with the SSID and optional PWD pair information stored locally.

In some example embodiments, the terminal device 130 may transmit (348) a probe request message to the network device 110. The probe request message may comprise the address information of the terminal device 130, for example the MAC address of the terminal device 130. In some example embodiments, the probe request message may further comprise an existing SSID. Alternatively, or in addition, the SSID comprised in the probe request message may be encrypted at the terminal device 130, for example using the security key of the terminal device 130.

In response to receiving (351) the probe request message, the network device 110 determine (354) the SSID for the terminal device 130 based, at least in part, on the address information. For example, in the cases where the probe request message comprises an existing SSID, the network device 110 may determine whether the existing SSID is associated with the address information.

As an example, the network device 110 may obtain the MAC address and the existing SSID from the probe request message. The network device 110 may further lookup the mapping relationship table to check whether the existing SSID is stored at the local database based on the mapping relationship of the MAC address and SSID. If the existing SSID in the probe request message is encrypted at the terminal device 130 using the security key of the terminal device 130, the network device 110 may need to decrypt the existing SSID to restore the real SSID based on the security key.

For an example, in the static MAC address cases, the network device 110 may search the mapping table from MAC address to SSID based on the MAC address of the terminal device 130. In the dynamic or random MAC address cases, the network device 110 may calculate a base address for the terminal device 130 through the MAC address of the terminal device 130 based on the MAC address generation rule. The network device 110 may further search the mapping table from base address to SSID based on the base address of the terminal device 130.

If the network device 110 determines that the existing SSID is associated with the address information, the network device 110 may determine (354) the existing SSID as the SSID for the terminal device 130. That is, if the existing SSID provided by the terminal device 130 is stored at local database of the network device 110, the network device 110 may determine (357) to respond to the terminal device 130 with the SSID. In some example embodiments, the network device 110 may associate the SSID with the address information. Alternatively, as the association already stored, the network device 110 may respond to the terminal device 130 with the SSID without associating the SSID with the address information again.

In responding to the terminal device 130, the network device 110 may direct (360) the AP 120 to create (363) the VBSS with the SSID for the terminal device 130. The AP 120 may be selected from the plurality of APs 120, for example based on RCPI or RSSI. For example, the AP 120 with best RSSI measured based on the probe request frame received (351) by the network device 110 may be selected as the AP 120 creating (363) the VBSS. The AP 120 creating (363) the VBSS and the AP 120 creating (324) the VBSS may be the same or different. The AP 120 may also send (366) a probe response message comprising the SSID to the terminal device 130. The SSID comprised in the sent (366) probe response message may be comprised in the received (351) probe request message.

Otherwise, if the network device 110 determines that the existing SSID is not associated with the address information, the network device 110 (for example, the controller) will not respond to the terminal device 130. In such situation, the terminal device 130 may not automatically connect to the distributed network 101.

Example embodiments regarding the probe request message comprising the existing SSID have been described. In some example embodiments, the received (351) probe request message may not carry an existing SSID or SSID information. In such cases, the network device 110 may obtain the address information such as the MAC address based on the received (351) probe request message. The network device 110 may determine whether an existing SSID is associated with the obtained address information. For example, the network device 110 may check whether an existing SSID is stored at the local database based on the mapping relationship of the MAC address and SSID.

For an example, in the static MAC address cases, the network device 110 may search the mapping table from MAC address to SSID based on the MAC address of the terminal device 130. In the dynamic or random MAC address cases, the network device 110 may calculate a base address for the terminal device 130 through the MAC address of the terminal device 130 based on the MAC generation mode or rule. The network device 110 may further search the mapping table from base address to SSID based on the base address of the terminal device 130.

If an existing SSID is found stored at local database, the network device 110 may determine (357) to respond to the terminal device 130 with the SSID. In some example embodiments, the network device 110 may associate the SSID with the address information. Alternatively, as the association already stored, the network device 110 may respond to the terminal device 130 with the SSID without associating the SSID with the address information again.

In responding to the terminal device 130, the network device 110 may direct (360) the AP 120 to create (363) the VBSS with the SSID for the terminal device 130. The AP 120 may be selected from the plurality of APs 120, for example based on RCPI or RSSI. For example, the AP 120 with best RSSI measured based on the probe request frame received (351) by the network device 110 may be selected as the AP 120 creating (363) the VBSS. The AP 120 creating (363) the VBSS and the AP 120 creating (324) the VBSS may be the same or different. The AP 120 may also send (366) a probe response message comprising the SSID to the terminal device 130. The SSID comprised in the sent (366) probe response message may be obtained from the local database based on the MAC address comprised in the received (351) probe request message.

Otherwise, if the network device 110 determines that no existing SSID is associated with the address information, the network device 110 (for example, the controller) will not respond to the terminal device 130. In such situation, the terminal device 130 may not automatically connect to the distributed network 101. Alternatively, or in addition, the network device 110 may take the terminal device 130 as a new terminal device 130 and generate a new unique SSID based on the address information and the address generation mode indication of the terminal device 130. The generation of the SSID may be similar to the determination (315) of the SSID. After that, the network device 110 may respond to the terminal device with the newly generated SSID.

In some example embodiments, in response to receiving (369) the probe response message, the terminal device 130 may access the distributed network 101 using the SSID comprised in the probe response message. For example, the terminal device 130 may associate (372) a VBSS with the SSID. The VBSS being associated (375) is created by the AP 120 controlled by the network device 110. In this way, the terminal device 130 may associate the private VBSS with the SSID after retrieve the local database automatically.

In this way, the terminal device may fast associate the existing network based on the association or bundling rule between the existing SSID and the MAC address of the terminal device.

Example embodiments regarding the SSID association with address information have been described. It is to be understood that the above described example embodiments regarding SSID association with address information are only for the purpose of illustration, without suggesting any limitations. By using the proposed SSID association with address information, the uniqueness of the SSID used for a respective terminal device to associate with the distributed network may be ensured. In addition, it may enable the terminal device to fast associate the existing network based on the association or bundling rule between the existing SSID and the MAC address of the terminal device. Moreover, this approach is applicable for dynamic or random MAC address allocation case for terminal device based on flexible association approach. In this way, the distributed network coverage and performance may be improved.

### Example Methods and Apparatuses

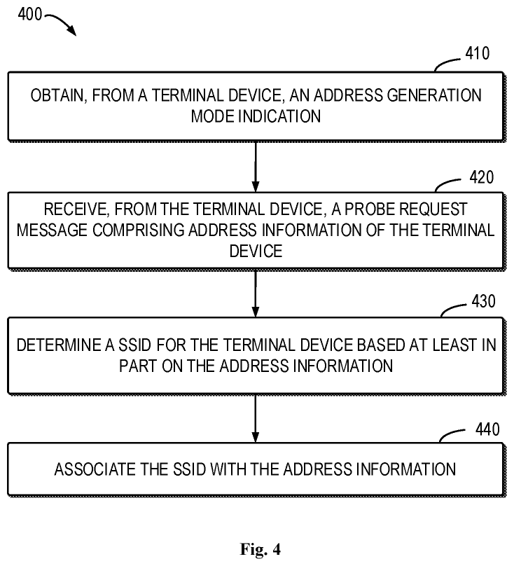

FIG. 4 shows a flowchart of an example method 400 implemented at a network device in accordance with some example embodiments of the present disclosure. For the purpose of discussion, the method 400 will be described from the perspective of a network device 110 in FIG. 1.

At block 410, the network device 110 obtains, from a terminal device 130, an address generation mode indication. The address generation mode indication is indicative of address information of the terminal device 130 being generated in a static mode or a dynamic mode. In some example embodiments, the network device 110 obtains the address generation mode indication by negotiating an address generation mode with the terminal device 130 and determining the address generation mode based on the negotiated address generation mode. Alternatively, or in addition, the network device 110 obtains the address generation mode by: receiving capability information from the terminal device 130; and obtaining the address generation mode indication based on the capability information.

At block 420, the network device 110 receives, from the terminal device 130, a probe request message comprising the address information of the terminal device. At block 430, the network device 110 determines an SSID for the terminal device 130 based, at least in part, on the address information.

In some example embodiments, the network device 110 determines the SSID for the terminal device 130 based, at least in part, on the address information by: generating the SSID based on the address information and the address generation mode indication.

In some example embodiments, the network device 110 determines the SSID for the terminal device 130 based, at least in part, on the address information by: in accordance with a determination that the probe request message comprises an existing SSID, determining whether the existing SSID is associated with the address information; and in accordance with a determination that the existing SSID is associated with the address information, determining the existing SSID as the SSID.

In some example embodiments, the network device 110 determines the SSID for the terminal device 130 based, at least in part, on the address information by: determining whether an existing SSID is associated with the address information; and in accordance with a determination that the existing SSID is associated with the address information, determining the existing SSID as the SSID.

At block 440, the network device 110 associates the SSID with the address information. In some example embodiments, the address generation mode indication indicates a static mode. In such cases, the network device 110 associates the SSID with the address information by: obtaining a medium access control, MAC, address comprised in the address information; and associating the SSID with the MAC address.

In some example embodiments, the address generation mode indication indicates a dynamic address generation rule. In such cases, the network device 110 associates the SSID with the address information by: obtaining a medium access control, MAC, address comprised in the address information; obtaining a base address based on the MAC address and the dynamic address generation rule; and associating the SSID with the base address.

In some example embodiments, the network device 110 is further configured to store an association between the SSID and the address information at the network device 110.

In some example embodiments, the network device 110 is further configured to: cause an AP 120 controlled by the network device 110 to create a VBSS with the SSID for the terminal device 130; and trigger a probe response message comprising the SSID to be sent by the AP 120 to the terminal device 130. In some example embodiments, the network device 110 is further configured to: in response to detecting that the terminal device 130 is out of coverage of the VBSS, cause the AP 120 to destroy or remove the VBSS.

In some example embodiments, an apparatus capable of performing any of the method 400 (for example, a network device 110 in FIG. 1) may comprise means for performing the respective operations of the method 400. The means may be implemented in any suitable form. For example, the means may be implemented in a circuitry or software module or a combination thereof. The apparatus may be implemented as or included in the network device 110 in FIG. 1.

In some example embodiments, the apparatus comprises means for obtaining, from a terminal device 130, an address generation mode indication. The address generation mode indication indicates that address information of the terminal device 130 is generated in a static mode or a dynamic mode. In some example embodiments, the means for obtaining the address generation mode indication comprises: means for negotiating an address generation mode with the terminal device 130, and means for determining the address generation mode indication based on the negotiated address generation mode. Alternatively, or in addition, the means for obtaining the address generation mode indication comprises: means for receiving capability information from the terminal device 130; and means for obtaining the address generation mode indication based on the capability information.

In some example embodiments, the apparatus further comprises: means for receiving, from the terminal device 130, a probe request message comprising the address information of the terminal device; and means for determining an SSID for the terminal device 130 based, at least in part, on the address information.

In some example embodiments, the means for determining the SSID for the terminal device 130 based, at least in part, on the address information comprises: means for generating the SSID based on the address information and the address generation mode indication.

In some example embodiments, the means for determining the SSID for the terminal device 130 based, at least in part, on the address information comprises: means for in accordance with a determination that the probe request message comprises an existing SSID, determining whether the existing SSID is associated with the address information; and means for in accordance with a determination that the existing SSID is associated with the address information, determining the existing SSID as the SSID.

In some example embodiments, the means for determining the SSID for the terminal device 130 based, at least in part, on the address information comprises: means for determining whether an existing SSID is associated with the address information; and means for in accordance with a determination that the existing SSID is associated with the address information, determining the existing SSID as the SSID.

In some example embodiments, the apparatus further comprises means for associating the SSID with the address information. In some example embodiments, the address generation mode indication indicates a static mode. In such cases, the means for associating the SSID with the address information comprises: means for obtaining a medium access control, MAC, address comprised in the address information; and means for associating the SSID with the MAC address.

In some example embodiments, the address generation mode indication indicates a dynamic address generation rule. In such cases, the means for associating the SSID with the address information comprises: means for obtaining a medium access control, MAC, address comprised in the address information; means for obtaining a base address based on the MAC address and the dynamic address generation rule; and means for associating the SSID with the base address.

In some example embodiments, the apparatus further comprises means for storing an association between the SSID and the address information at the apparatus.

In some example embodiments, the apparatus further comprises: means for causing an access point controlled by the apparatus to create a VBSS with the SSID for the terminal device 130; and means for triggering a probe response message comprising the SSID to be sent by the access point to the terminal device 130. In some example embodiments, the apparatus further comprises: means for in response to detecting that the terminal device 130 is out of coverage of the VBSS, causing the access point to destroy or remove the VBSS.

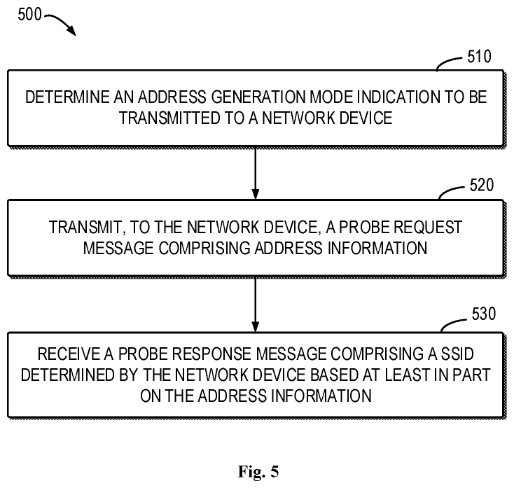

FIG. 5 shows a flowchart of an example method 500 implemented at a terminal device in accordance with some example embodiments of the present disclosure. For the purpose of discussion, the method 500 will be described from the perspective of a terminal device 130 in FIG. 1.

At block 510, the terminal device 130 determines an address generation mode indication to be transmitted to a network device 110 in a network 101. The address generation mode indication is indicative of address information of the terminal device 130 being generated in a static mode or a dynamic mode. In some example embodiments, the terminal device 130 determines the address generation mode indication by negotiating an address generation mode with the network device 110 and determining the address generation mode indication based on the negotiated address generation mode.

In some example embodiments, the terminal device 130 is further configured to: transmit capability information to the network device 110. The capability information comprises the address generation mode indication.

At block 520, the terminal device 130 transmits, to the network device 110, a probe request message comprising the address information of the terminal device 130. In some example embodiments, the terminal device 130 transmits the probe request message by transmitting the probe request message comprising a MAC address of the terminal device 130. In some example embodiments, the terminal device 130 transmits the probe request message by transmitting the probe request message comprising an existing SSID of the terminal device 130.

At block 530, the terminal device 130 receives a probe response message comprising an SSID. The SSID is determined by the network device 110 based, at least in part, on the address information. In some example embodiments, the terminal device 130 receives the probe response message by receiving, from an AP 120 controlled by the network device 110, the probe response message.

In some example embodiments, the terminal device 130 is further configured to: in response to receiving the probe response message, access the network 101 using the SSID comprised in the probe response message.

In some example embodiments, the terminal device 130 is further configured to: associate a VBSS with the SSID. The VBSS is created by an AP 120 controlled by the network device 110.

In some example embodiments, an apparatus capable of performing any of the method 500 (for example, the terminal device 130 in FIG. 1) may comprise means for performing the respective operations of the method 500. The means may be implemented in any suitable form. For example, the means may be implemented in a circuitry or software module or a combination thereof. The apparatus may be implemented as or included in the terminal device 130 in FIG. 1.

In some example embodiments, the apparatus comprises means for determining an address generation mode indication to be transmitted to a network device 110 in a network 101. The address generation mode indication indicates that address information of the apparatus is generated in a static mode or a dynamic mode. In some example embodiments, the means for determining the address generation mode indication comprises: means for negotiating an address generation mode with the network device 110, and means for determining the address generation mode indication based on the negotiated address generation mode.

In some example embodiments, the apparatus further comprises means for transmitting capability information to the network device 110. The capability information comprises the address generation mode indication.

In some example embodiments, the apparatus further comprises means for transmitting, to the network device 110, a probe request message comprising the address information of the apparatus. In some example embodiments, the means for transmitting the probe request message comprises: means for transmitting the probe request message comprising a MAC address of the apparatus. In some example embodiments, the means for transmitting the probe request message comprises: means for transmitting the probe request message comprising an existing SSID of the apparatus.

In some example embodiments, the apparatus further comprises means for receiving a probe response message comprising an SSID. The SSID is determined by the network device 110 based, at least in part, on the address information. In some example embodiments, the means for receiving the probe response message comprises: means for receiving, from an AP 120 controlled by the network device 110, the probe response message.

In some example embodiments, the apparatus further comprises means for: in response to receiving the probe response message, accessing the network 101 using the SSID comprised in the probe response message.

In some example embodiments, the apparatus further comprises means for: associating a VBSS with the SSID. The VBSS is created by an AP 120 controlled by the network device 110.

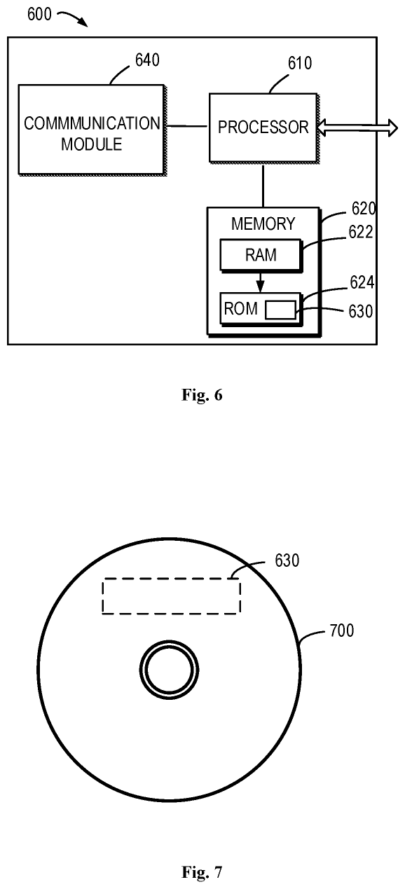

FIG. 6 is a simplified block diagram of a device 600 that is suitable for implementing example embodiments of the present disclosure. The device 600 may be provided to implement a communication device, for example, the terminal device 130 or the network device 110 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the memory, e.g., ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIGS. 3 to 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 which may be in form of CD, DVD or other optical storage disk. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIG. 4 and FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-40. (canceled)

41. An apparatus comprising:
at least one processor; and
at least one memory storing instructions that, when executed by the at least one processor, cause the apparatus at least to:
obtain, from a terminal device, an address generation mode indication, the address generation mode indication indicative of an address information of the terminal device being generated in a static mode or a dynamic mode;
receive, from the terminal device, a probe request message comprising the address information of the terminal device;
determine a service set identifier, SSID, for the terminal device based, at least in part, on the address information; and
associate the SSID with the address information.

42. The apparatus of claim 41, further configured to obtain the address generation mode indication by:
negotiating an address generation mode with the terminal device; and
determining the address generation mode indication based on the negotiated address generation mode.

43. The apparatus of claim 41, further configured to obtain the address generation mode indication by:
receiving capability information from the terminal device; and
obtaining the address generation mode indication based on the capability information.

44. The apparatus of claim 41, further configured to determine the SSID for the terminal device based, at least in part, on the address information by:
generating the SSID based on the address information and the address generation mode indication.

45. The apparatus of claim 41, wherein the address generation mode indication indicates a static mode; and
wherein the apparatus is further configured to associate the SSID with the address information by:
obtaining a medium access control, MAC, address comprised in the address information; and
associating the SSID with the MAC address.

46. The apparatus of claim 41, wherein the address generation mode indication indicates a dynamic address generation rule; and
wherein the apparatus is further configured to associate the SSID with the address information by:
obtaining a medium access control, MAC, address comprised in the address information;
obtaining a base address based on the MAC address and the dynamic address generation rule; and
associating the SSID with the base address.

47. The apparatus of claim 41, further configured to determine the SSID for the terminal device at least in part based on the address information by:
in accordance with a determination that the probe request message comprises an existing SSID, determining whether the existing SSID is associated with the address information; and
in accordance with a determination that the existing SSID is associated with the address information, determining the existing SSID as the SSID.

48. The apparatus of claim 41, further configured to determine the SSID for the terminal device at least in part based on the address information by:
determining whether an existing SSID is associated with the address information; and
in accordance with a determination that the existing SSID is associated with the address information, determining the existing SSID as the SSID.

49. The apparatus of claim 41, further configured to:
store an association between the SSID and the address information at the apparatus.

50. The apparatus of claim 41, further configured to:
cause an access point controlled by the apparatus to create a virtual basic service set, VBSS, with the SSID for the terminal device; and
trigger a probe response message comprising the SSID to be sent by the access point to the terminal device.

51. An apparatus comprising:
at least one processor; and
at least one memory storing instructions that, when executed by the at least one processor, cause the apparatus at least to:
determine an address generation mode indication to be transmitted to a network device in a network, the address generation mode indication indicative of an address information of the apparatus being generated in a static mode or a dynamic mode;
transmit, to the network device, a probe request message comprising the address information of the apparatus; and
receive a probe response message comprising a service set identifier, SSID, the SSID being determined by the network device based, at least in part, on the address information.

52. The apparatus of claim 51, further configured to:
in response to receiving the probe response message, access the network using the SSID comprised in the probe response message.

53. The apparatus of claim 51, further configured to determine the address generation mode indication by:
negotiating an address generation mode with the network device; and
determining the address generation mode indication based on the negotiated address generation mode.

54. The apparatus of claim 51, further configured to:
transmit capability information to the network device, the capability information comprising the address generation mode indication.

55. The apparatus of claim 52, further configured to:
associate a virtual basic service set, VBSS, with the SSID, the VBSS being created by an access point controlled by the network device.

56. The apparatus of claim 52, further configured to transmit the probe request message by:
transmitting the probe request message comprising a medium access control, MAC, address of the apparatus.

57. The apparatus of claim 52, further configured to transmit the probe request message by:
transmitting the probe request message comprising an existing SSID of the apparatus.

58. The apparatus of claim 51, wherein the apparatus is a terminal device.

59. A method comprising:
obtaining, by a network device and from a terminal device, an address generation mode indication, the address generation mode indication indicating that an address information of the terminal device is generated in a static mode or a dynamic mode;
receiving, from the terminal device, a probe request message comprising the address information of the terminal device;
determining a service set identifier, SSID, for the terminal device based, at least in part, on the address information; and
associating the SSID with the address information.

60. A method comprising:
determining, by a terminal device, an address generation mode indication to be transmitted to a network device in a network, the address generation mode indication indicating that an address information of the apparatus is generated in a static mode or a dynamic mode;
transmitting, to the network device, a probe request message comprising the address information of the terminal device; and
receiving a probe response message comprising a service set identifier, SSID, the SSID being determined by the network device based, at least in part, on the address information.
